(19) United States
(12) Patent Application Publication
(10) Pub. No.: US 2015/0329345 A1
(43) Pub. Date: Nov. 19, 2015

(54) METHOD AND SYSTEM FOR PACKAGING AND SELLING ALCOHOLIC BEVERAGES

(71) Applicant: Danny Harpe, Nicholasville, KY (US)

(72) Inventor: Danny Harpe, Nicholasville, KY (US)

(21) Appl. No.: 14/279,431

(22) Filed: May 16, 2014

(51) Int. Cl. B67D 1/08; G06Q 90/00; B65B 3/04; B65B 7/28; B67D 1/12; B67D 1/00

(52) U.S. Cl. CPC B67D 1/0804; B67D 1/1277; B67D 1/0805; B67D 1/0004; B65B 3/04; B65B 7/28; G06Q 90/00

(57) ABSTRACT

Selling a retail alcoholic beverage includes filling a wooden barrel with an alcoholic beverage, the barrel being sized to be transported within a retail location, without the aid of assisting equipment, by a person of average strength. This method also includes sealing one opening of the wooden barrel with a liquid-proof closure wherein the liquid-proof closure is removable by an eventual consumer of the alcoholic beverage in the wooden barrel; and sealing another opening of the wooden barrel with a dispensing valve wherein the dispensing valve is operable between an open position and a closed position. Ultimately, the method includes offering the wooden barrel, filled with the alcoholic beverage and sealed with the liquid-proof closure dispensing valve, for sale to a retail establishment from whom the eventual consumer of the alcoholic beverage can purchase the wooden barrel.

### BACKGROUND

1. Field of the Invention

The present invention relates generally to a selling alcohol beverages and, in particular, effective container design for alcoholic beverages.

2. Description of Related Art

Packaging is the technology of enclosing or protecting products for distribution, storage, sale, and use. Packaging can also refer to the process of design, evaluation, and production of packages. Packaging and package labeling satisfy several objectives. Two such objectives include physical protection and barrier protection. Physical protection refers to how the objects enclosed in the package may require protection from, among other things, mechanical shock, vibration, electrostatic discharge, compression, temperature, etc. Barrier protection refers to a barrier from oxygen, water vapor, dust, etc., that may be required. Keeping the contents clean, fresh, sterile and safe for the intended shelf life is a primary function. At the consumer end, the packaging barrier is broken and measured amounts of material can be removed for subsequent end use.

Another function of packaging relates to marketing. The packaging and labels can be used by marketers to encourage potential buyers to purchase the product. Package graphic design and physical design have been important and constantly evolving phenomenon for several decades. Marketing communications and graphic design are often applied to the surface of the package and in many cases the point of sale display. Most packaging whether it be through its graphic design or its shape and size is designed to reflect a brand's message and identity.

One additional function of packaging is to provide convenience. Packages can have features that add convenience in distribution, handling, stacking, display, sale, opening, reclosing, use, dispensing, reuse, recycling, and ease of disposal.

Packaging of a product at a retail location can play a substantial role in catching a customer's attention and enticing the customer to purchase the product. One product that already comes packaged in a variety of sizes and containers is alcoholic beverages. In many instances, the shape and size of a bottle containing an alcoholic beverage can vary based on the type of alcohol that the bottle is meant to hold.

### BRIEF SUMMARY

One aspect of the present invention relates to a method of packaging a retail alcoholic beverage that includes filling a wooden barrel with an alcoholic beverage, the wooden barrel being sized to be transported within a retail location, without the aid of assisting equipment, by a person of average strength. This method also includes sealing a first opening of the wooden barrel with a liquid-proof closure, after the wooden barrel is filled with the alcoholic beverage, wherein the liquid-proof closure is removable by an eventual consumer of the alcoholic beverage in the wooden barrel; and sealing a second opening of the wooden barrel with a dispensing valve, before the wooden barrel is filled with the alcoholic beverage, wherein the dispensing valve is operable between an open position and a closed position. Ultimately, the method includes offering the wooden barrel, filled with the alcoholic beverage and sealed with the liquid-proof closure dispensing valve, for sale to a retail establishment from whom the eventual consumer of the alcoholic beverage can purchase the wooden barrel.

Another aspect of the present invention relates to a method of selling a retail alcoholic beverage includes receiving a wooden barrel filled with an alcoholic beverage, the wooden barrel being sized to be transported within a retail location, without the aid of assisting equipment, by a person of average strength. In particular; the wooden barrel includes a first opening sealed with a liquid-proof closure, wherein the liquid-proof closure is removable by an eventual consumer of the alcoholic beverage in the wooden barrel; and a second opening sealed with a dispensing valve, wherein the dispensing valve is operable between an open position and a closed position. Ultimately, the method includes offering the wooden barrel, filled with the alcoholic beverage and sealed with the liquid-proof closure dispensing valve, for sale at a retail establishment to the eventual consumer of the alcoholic beverage within the wooden barrel.

Yet another aspect of the present invention relates to a retail alcoholic beverage consisting essentially of a wooden barrel filled with an alcoholic beverage, the wooden barrel being sized to be transported within a retail location, without the aid of assisting equipment, by a person of average strength. In particular, the wooden barrel includes a first opening sealed with a liquid-proof closure, wherein the liquid-proof closure is removable by an eventual consumer of the alcoholic beverage in the wooden barrel; and a second opening sealed with a dispensing valve, wherein the dispensing valve is operable between an open position and a closed position. The wooden barrel also includes a plurality of wooden staves spanning between a first head and a second head; a first plurality of bands encircling the plurality of wooden staves proximate the first head; and a second plurality of bands encircling the plurality of wooden staves proximate the second head.

### BRIEF DESCRIPTION OF THE DRAWINGS

FIG. 1 illustrates a wooden barrel in accordance with the principles of the present invention oriented horizontally.

FIG. 2 illustrates a side view of the wooden barrel of FIG. 1.

FIG. 3 illustrates an alternative wooden barrel in accordance with the principles of the present invention oriented vertically.

FIG. 4 illustrates a front view of the wooden barrel of FIG. 3.

FIG. 5A is a flowchart of an exemplary method of packaging alcoholic beverages for a retailer in accordance with the principles of the present invention.

FIG. 5B is a flowchart of an exemplary method of selling alcoholic beverages from a retail location in accordance with the principles of the present invention.

### DETAILED DESCRIPTION

As commonly known, a liquor store is a retail shop that sells prepackaged alcoholic beverages—typically in bottles—intended to be consumed off the store's premises. For purposes of the present disclosure, the term “retail” is intended to mean the sale of goods and/or services from individuals or businesses to an end-user. Thus a retail store of an alcoholic beverage sells beverages to consumers and can receive items to sell from distributors, suppliers or other up-channel partners.

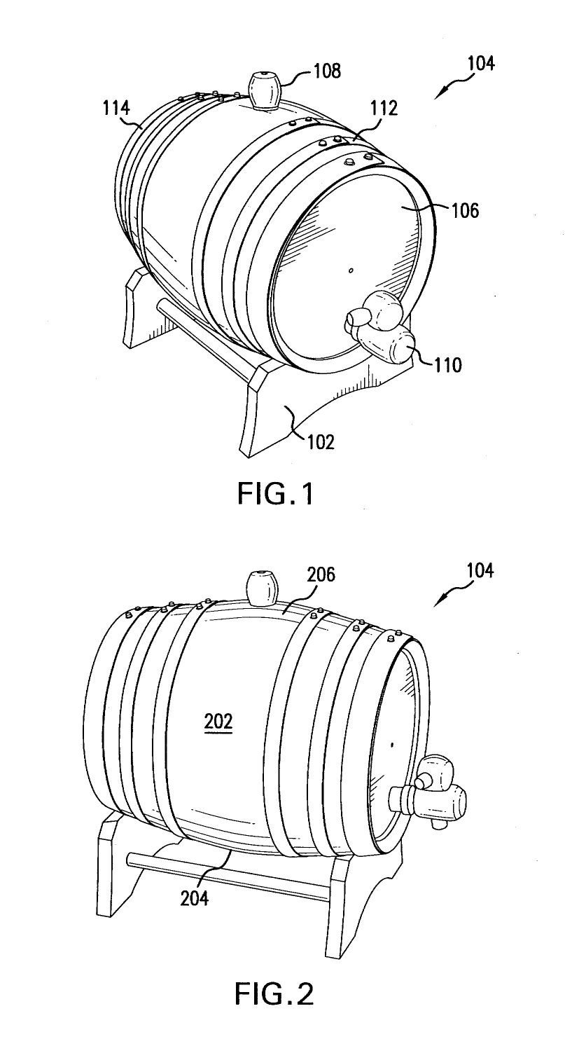

FIG. 1 illustrates a wooden barrel in accordance with the principles of the present invention oriented horizontally. In particular, the wooden barrel is filled with an alcoholic beverage and the wooden barrel is sized, such that when it is filled, it can be transported within a retail location, or from the retail location, without the aid of assisting equipment, by a person of average strength. Of course retail locations can include shopping carts and the like that make transporting the wooden barrel easier but the barrel is of the size that such assisting equipment is not needed for most customers.

The size of the wooden barrel is described in this manner to distinguish it from large casks and barrels conventionally used by winemakers and distillers to craft alcoholic beverages. Such barrels are far too large to be sold to a consumer at a retail location. The sheer size and weight of such a conventional barrel would not allow it to be a convenient or useful way to package alcoholic beverage for retail sale. Another distinction about the size of the present barrel is that contents of the present barrel are dispensed for direct consumption by a person rather than, as in the case of large barrels, dispensed into multiple smaller containers for storage or shipment. The table below provides some example size of wooden barrels that are appropriately sized for retail display and sale of alcoholic beverages. As shown in the table, the relative sizes of the dimensions result in a barrel that is aesthetically and visually similar to large wooden barrels and therefore can establish, or benefit from, a link in a consumer's thinking between barrels and alcoholic beverages.

| Barrel Size | | Height | | Head Diameter | | Belly Diameter | |
|---|---|---|---|---|---|---|---|
| 1 | Liter | 6-7 | inches | 4-5 | inches | 5-6 | inches |
| 2 | Liters | 7-8 | inches | 5-6 | inches | 6-7 | inches |
| 5 | Liters | 9.5-10.5 | inches | 6.5-7.5 | inches | 8-9 | inches |
| 10 | Liters | 11.5-12.5 | inches | 8-9 | inches | 10-11 | inches |
| 20 | Liters | 15-16 | inches | 10.5-11.5 | inches | 12-13 | inches |

Referring back to FIG. 1, the barrel 104 is oriented horizontally on a stand 102. The stand is an optional part of the barrel 104 and many functionally-equivalent variations can be selected that securely hold the barrel 104 in position. The barrel 102 includes a first opening in one or more of the barrel staves, commonly referred to as a bung hole, which can be sealed with a cork 108 or similar closure mechanism. The cork 108 creates a seal of the bung hole of the barrel 104 which is liquid-proof. In other words, with the cork 108 properly in place, the liquid contents of the barrel 104 cannot leak out nor can outside contaminants enter the inside of the barrel 104.

The barrel 104 also includes another opening; this one in the head 106, which is sealed with a spigot 110. In its most general sense, the spigot 110 is a valve that is operable between an open position and a closed position. When in the open position, the valve 110 permits the contents of the barrel 104 to exit in a controlled manner. In the closed position, the valve 110 seals the opening and prevents the contents of the barrel 110 from exiting. The barrel 104 includes a head 106 on each end and bands that encircle the body of the barrel 104.

FIG. 2 illustrates a side view of the wooden barrel of FIG. 1. The barrel 104 is preferably constructed similar to traditional, large barrels. Accordingly, the barrel 104 can include a plurality of staves 206 that bulge outwardly at the belly 204 of the barrel 104 as compared with the head 106. Also, there are a plurality of bands which encircle the staves 206. One plurality of bands 114 (e.g., 3 bands) encircle the staves at an end near one of the heads 106 and another plurality of bands 112 (e.g., 3 bands) encircle the staves 206 at an opposite end near the other head 106. Three bands are customary but one of ordinary skill will recognize that other numbers of bands can be selected without departing from the scope of the present invention. In FIG. 2, the contents within the barrel 104 are indicated by reference numeral “202” and can, for example, be an alcoholic beverage.

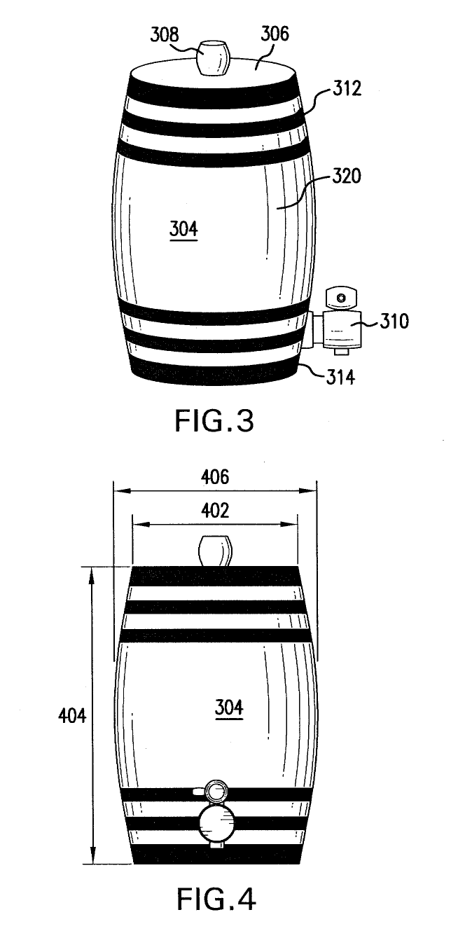

FIG. 3 illustrates an alternative wooden barrel in accordance with the principles of the present invention oriented vertically. In the embodiment of FIG. 3, the barrel 304 can securely balance on one of its head regions 306 so as to render the stand 102 of FIG. 1 unnecessary. The barrel of FIG. 3 is similar to that of FIG. 1 and FIG. 2 in that a plurality of bands 312 are located near one head 306 and another plurality of bands 314 are located near the opposite head. These pluralities 312, 314 of bands encircle a plurality of staves 320 that span from one head 306 to the other. The bands 312, 314 are depicted as solid black in FIG. 3. However, one of ordinary skill will recognize that the bands can be various types of metal (e.g., stainless steel, galvanized steel, brass, copper, etc.) without departing from the scope of the present invention. Although the barrels of FIG. 1 and FIG. 3 include the bands that encircle the staves, these bands (because of the smaller size of the barrels) may serve more of a decorative function rather than functional one.

The barrel of FIG. 3 also includes a closure mechanism 308 sealing one opening of the barrel 304 and a spigot 310 sealing another opening of the barrel 304. In this embodiment, however, the opening sealed by the closure mechanism 308 is located in the head 306 and the opening sealed by the spigot 310 is located in one or more of the staves 320.

FIG. 4 illustrates a front view of the wooden barrel of FIG. 3. In FIG. 4, the various dimensions of the barrel 304, which correspond to the above table, are highlighted. In particular the barrel 304 can have a height 404, a head diameter 402 and a belly diameter 406. These measurements are applicable to either the barrel 104 of FIG. 1 or the barrel 304 of FIG. 3.

One particular wood that can be used to construct the wooden barrels of FIG. 1-FIG. 4 is white oak; although, other types of wood could be used without departing from the scope of the present invention. The outside of the wooden barrel may be lacquered to provide a protective and attractive surface or it could be left unfinished. Also, the outside appearance of the wooden barrel can be customized with a logo, graphics, or other visual attributes. The colors of the wooden barrel or other customizations can be related to the type of alcoholic beverage within the wooden barrel, the retail location selling the wooden barrel, the geographical location where the wooden barrel is sold, and a variety of other factors as well.

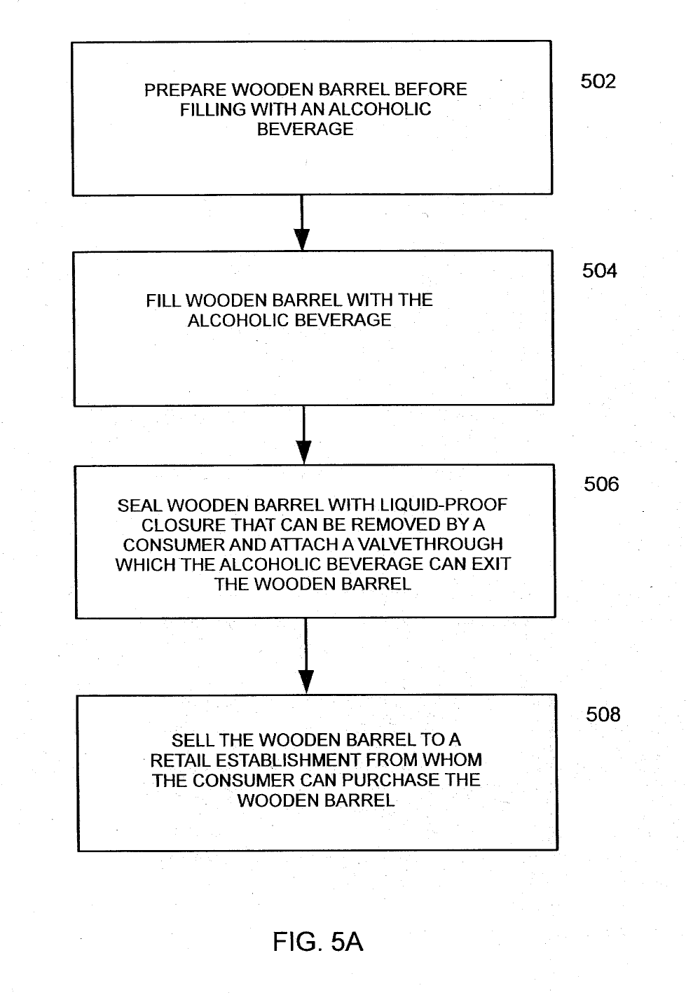

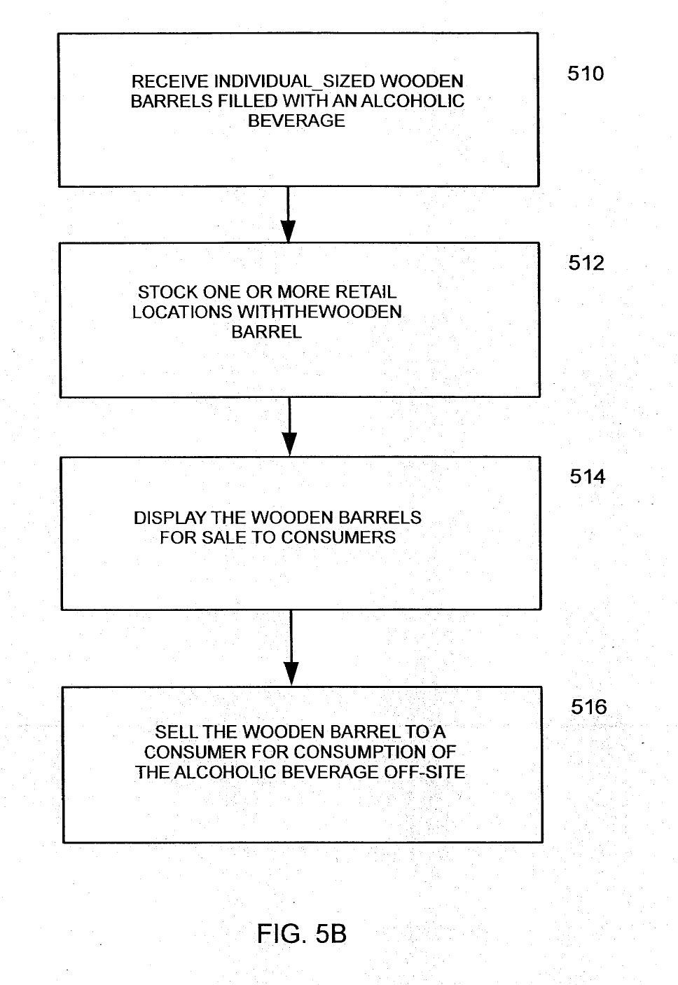

FIG. 5A is a flowchart of an exemplary method of packaging alcoholic beverages for a retailer in accordance with the principles of the present invention. Before filling the wooden barrel with an alcoholic beverage, the inside of the barrel can be prepared in a variety of different ways in step 502. For example, flavoring such as apple-wood, mesquite, cherry or other woods could be added by smoking the wooden barrel with such woods. Also, the white oak could be charred without any extra flavors being added. Allowing a liquid to soak within the barrel for a predetermined time period, and then discarding that liquid, could also be used to infuse additional flavors into the wooden barrel. In step 504, the wooden barrel is filled with an alcoholic beverage. This filling can be accomplished through the bung hole described earlier. As is known to one of ordinary skill, enough headspace is left within the filled wooden barrel to allow for contraction and expansion of the barrel and/or its contents. According to step 506, two different openings through the wooden barrel are sealed. One opening is sealed with a valve that opens and closes to allow the barrel contents to be dispensed. This opening can be sealed before the wood barrel is filled (in step 504) with the alcoholic beverage. The second opening is sealed once the wooden barrel is filled with the alcoholic beverage. Once both openings are sealed, the wooden barrel securely contains and protects the alcoholic beverage within. At this stage, the wooden barrel can, in step 508, be sold or delivered to a retail establishment who will, in turn, offer the wooden barrel for sale to a consumer. One of ordinary skill will recognize that additional intermediate entities may participate in the flowchart of FIG. 5A such that the entity that fills and seals the wooden barrel could provide those barrels to an entity that is indirectly involved with providing the wooden barrels to a retail location for purchase by a consumer.

FIG. 5B is a flowchart of an exemplary method of selling alcoholic beverages from a retail location in accordance with the principles of the present invention. From the perspective of the retail location, the filled and sealed wooden barrels are received in step 510. In steps 512 and 514, a retailer can stock and display the wooden barrels at one or more retail locations for sale. Thus, in step 514, the retail location is able to sell sealed wooden barrels, full of an alcoholic beverage, to a consumer. The consumer may then consume the alcoholic beverage and even re-fill the wooden barrel if desired.

In the above description, the contents of the wooden barrel were mainly referred to as an “alcoholic beverage”. Alcoholic beverages commonly associated with oak barrels are wine, bourbon, whiskey, and scotch. Other alcoholic beverages could be included as well, whether distilled or fermented. One of ordinary skill will recognize there are other products, such as balsamic vinegar, that are associated with wooden barrels but are not alcoholic beverages. Thus, embodiments of the present invention can also include retail sales and packaging of liquids other than alcoholic beverages.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of packaging a retail alcoholic beverage comprising:
filling a wooden barrel with an alcoholic beverage, the wooden barrel, when filled, being sized to be transported within a retail location, without the aid of assisting equipment, by a person of average strength;
sealing a first opening of the wooden barrel with a liquid-proof closure, after the wooden barrel is filled with the alcoholic beverage, wherein the liquid-proof closure is removable by an eventual consumer of the alcoholic beverage in the wooden barrel;
sealing a second opening of the wooden barrel with a dispensing valve, before the wooden barrel is filled with the alcoholic beverage, wherein the dispensing valve is operable between an open position and a closed position; and
offering the wooden barrel, filled with the alcoholic beverage and sealed with the liquid-proof closure dispensing valve, for sale to a retail establishment from whom the eventual consumer of the alcoholic beverage can purchase the wooden barrel.

2. The method of claim 1, comprising:
treating at least a portion of an inside surface of the wooden barrel before filling with the alcoholic beverage.

3. The method of claim 2, wherein treating comprises charring.

4. The method of claim 2, wherein treating comprises applying a flavor.

5. The method of claim 1, comprising:
varying an appearance of at least a portion of an outside surface of the wooden barrel.

6. The method of claim 5, wherein varying comprises customizing a visual appearance of the outside surface based upon a source of the alcoholic beverage.

7. The method of claim 5, wherein varying comprises customizing a visual appearance of the outside surface based upon an identity of the retail establishment.

8. The method of claim 5, wherein varying comprises applying lacquer to the portion of the outside surface.

9. The method of claim 1, wherein the wooden barrel comprises:
a plurality of wooden staves spanning between a first head and a second head;
a first plurality of bands encircling the plurality of wooden staves proximate the first head; and
a second plurality of bands encircling the plurality of wooden staves proximate the second head.

10. The method of claim 9, wherein:
the first opening is located on one of the plurality of staves; and
the second opening is located on the first head.

11. The method of claim 10, wherein the wooden barrel includes a stand configured to support the wooden barrel in a horizontal orientation.

12. The method of claim 9, wherein:
the first opening is located on the first head; and
the second opening is located in-between a pair of the second plurality of bands.

13. The method of claim 1, wherein an approximate volume of alcoholic beverage within the wooden barrel is one of 1 liter, 2 liters, 5 liters and 10 liters.

14. A method of selling a retail alcoholic beverage comprising:
receiving a wooden barrel filled with an alcoholic beverage, the wooden barrel being sized, when filled, to be transported within a retail location, without the aid of assisting equipment, by a person of average strength; wherein the wooden barrel comprises:
a first opening of the wooden barrel sealed with a liquid-proof closure, wherein the liquid-proof closure is removable by an eventual consumer of the alcoholic beverage in the wooden barrel;
a second opening of the wooden barrel sealed with a dispensing valve, wherein the dispensing valve is operable between an open position and a closed position; and
offering the wooden barrel, filled with the alcoholic beverage and sealed with the liquid-proof closure dispensing valve, for sale at a retail establishment to the eventual consumer of the alcoholic beverage within the wooden barrel.

15. The method of claim 14, wherein the wooden barrel comprises:
a plurality of wooden staves spanning between a first head and a second head;
a first plurality of bands encircling the plurality of wooden staves proximate the first head; and
a second plurality of bands encircling the plurality of wooden staves proximate the second head.

16. The method of claim 15, wherein:
the first opening is located on one of the plurality of staves; and
the second opening is located on the first head.

17. The method of claim 15, wherein:
the first opening is located on the first head; and
the second opening is located in-between a pair of the second plurality of bands.

18. The method of claim 14, wherein an approximate volume of alcoholic beverage within the wooden barrel is one of 1 liter, 2 liters, 5 liters and 10 liters.

19. A retail alcoholic beverage consisting essentially of:
a wooden barrel filled with an alcoholic beverage, the wooden barrel being sized, when filled, to be transported within a retail location, without the aid of assisting equipment, by a person of average strength; wherein the wooden barrel includes:
a first opening of the wooden barrel sealed with a liquid-proof closure, wherein the liquid-proof closure is removable by an eventual consumer of the alcoholic beverage in the wooden barrel;
a second opening of the wooden barrel sealed with a dispensing valve, wherein the dispensing valve is operable between an open position and a closed position;
a plurality of wooden staves spanning between a first head and a second head;
a first plurality of bands encircling the plurality of wooden staves proximate the first head; and
a second plurality of bands encircling the plurality of wooden staves proximate the second head.

20. The beverage of claim 19, wherein an approximate volume of alcoholic beverage within the wooden barrel is one of 1 liter, 2 liters, 5 liters and 10 liters.
